(19) United States
(12) Patent Application Publication
(10) Pub. No.: US 2024/0424616 A1
(43) Pub. Date: Dec. 26, 2024

(54) NICKEL BASED ACTIVE BRAZING MATERIAL

(71) Applicant: Liburdi Engineering Limited, Dundas (CA)

(72) Inventors: Alexandre B. GONTCHAROV, Mississauga (CA); Paul LOWDEN, Dundas (CA); Robyn REIS, Dundas (CA)

(21) Appl. No.: 18/214,387

(22) Filed: Jun. 26, 2023

(51) Int. Cl. B23K 35/30; C22C 19/00; C22C 19/05

(52) U.S. Cl. CPC B23K 35/3033; C22C 19/007; C22C 19/057

(57) ABSTRACT

A nickel based active brazing material for high temperature furnace and laser brazing of stainless steels, nickel and cobalt based alloys and superalloys, refractory metals and alloys in vacuum and inert gases for manufacturing and repair of turbine engine components and other articles comprising in weight percentage (wt. %) of (4.5-8.5)% Cr, (4.2-6.5)% Ti, (5.0-9.5)% Zr, (3.0-4.5)% Hf, (0.5-1.6)% Ta, (1.0-3.5)% Al, (0.5-1.7)% Si, (0-12.0)% Fe, (0-0.2)% Mo, (0-0.05)% W, and nickel to balance.

### FIELD

The specification relates to nickel based active brazing material. In particular, the specification relates to nickel based active brazing material in the form of powders, preforms, foils, sheets, rods, and/or wire that can be used for high temperature furnace and laser brazing of stainless steels, nickel and cobalt based polycrystalline, directionally solidified, single crystal alloys and superalloys, refractory metals and alloys in vacuum and inert gases for manufacturing and repair of turbine engine components and other articles.

### BACKGROUND

Joining and repair of turbine engine components manufactured from difficult to weld high gamma prime (γ′) superalloys can be accomplished using either welding with preheating or brazing. Welding of nickel based superalloys comprising more than 3 wt. % Al can result in the heat affected zone (HAZ) liquation and weld metal stress-strain cracking. Brazing, on the other hand, has the advantages over welding in terms of its capability in joining of hard-to-weld superalloys and in reducing of production cost by batch processing.

Brazing materials form joints either during cooling or isothermal solidification while a base material remains in a solid state. As such, brazing materials should have lower liquidus temperature then base materials.

Standards nickel (Ni) and cobalt (Co) based brazing materials comprising boron (B) and silicon (Si) melting point depressants (MPD) such as AMS 4775, AMS 4762, AMS4777, AMS 4778, AMS 4779, Amdry 775, Amdry DF-3, Amdry D15, and Amdry 788 with chemical composition provided in Table 1 have been used for manufacturing and repair of turbine engine components for decades.

TABLE 1
Typical Chemical Composition of Standard Ni and Co Based
Brazing Materials with B and Si Melting Point Depressants

| Brazing Material | Ni | Cr | Al | B | Si | Fe | Co | Ta | La |
|---|---|---|---|---|---|---|---|---|---|
| Amdry 775 | Bal | 15 | — | 3.5 | — | — | — | — | — |
| Amdry DF3 | Bal | 20 | — | 3 | — | — | 20 | 3 | 0.1 |
| Amdry D15 | Bal | 15 | 3.5 | 2.3 | — | — | 10.25 | 3.5 | — |
| Amdry 788 | 21 | 22 | — | 2 | 2 | — | Bal | — | — |
| AMS 4775 | Bal | 14 | — | 3.1 | 4.5 | 4.5 | — | — | — |
| AMS 4782 | Bal | 19 | — | — | 10 | — | — | — | — |
| AMS 4777 | Bal | 14 | — | 3.1 | 4.5 | 4.5 | — | — | — |
| AMS 4778 | Bal | — | — | 3.1 | 4.5 | — | — | — | — |
| AMS 4779 | Bal | — | — | 1.8 | 3.5 | 0.5 | — | — | — |

Conventional brazing (CB) has been used for jointing of components preassembled with the clearance of 0.05-0.2 mm to allow distribution of brazing material by capillary actions along faying surfaces followed by a diffusion cycle to enhance diffusion of boron into a base material to avoid formation of continues brittle boron based eutectics.

Wide Gap Brazing (WGB) employing either powder blends (mixtures) comprising brazing and high temperature filler powders as per Stephen J. Ferrigno et al. “Alloy Powder Mixture for Treating Alloy’, U.S. Pat. No. 4,830,934 (incorporated herein by reference) or utilizing infiltration of Amdry 775 and Amdry DF-3 brazing materials through a pre-sintered in the solid state Mar M247 and other filler powders also know as LPM™ process as per Josef Liburd et al., “Powder Metallurgy Repair Technique”, Patent U.S. Pat. No. 5,156,321 (incorporated herein by reference) have been used for joining and repair of surface dents, pitting and other defects in engine components.

R. Sparling et al “Liburdi Powder Metallurgy, Application for Manufacture and Repair of Gas Turbine Components”, Sixth International Charles Parson Turbine Conference, Dublin, Ireland, Sep. 16-18, 2003, pp. 987-1005 (incorporated herein by reference) demonstrated that two hours soaking at 1205° C. resulted in a formation of Mar M247-Amdry DF-3 LPM joints with the ultimate tensile strength (UTS) of 340 MPa (49.3 KSI) at 927° C. (1700° F.) while as it was found by experiments, the UTS of the brazed joints of just 2 mm in width produced using homogeneous Amdry DF-3 was just 146.9 MPa (21.3 KSI). However, even elevated strength of Mar M247-Amdry DF-3 LPT™ joints was not sufficient enough for repair of structural components that exercise significant stresses in service conditions.

Formation of thick diffusion layers and subsurface defects due to boron diffusion into the base material during furnace brazing was another drawback of brazing using boron based brazing materials. The thickness of the diffusion layers often exceeded 1313 μm (1.3 mm) as shown in FIG. 4a, which complicated repairs on thin trailing edges (TE) of nozzle guide vanes (NGV) manufactured from nickel based superalloys. Cobalt based materials were even more sensitive to boron forming voids and intergranular defects as show in FIG. 4b. In addition to above, boron significantly reduced oxidation resistance due to formation of thick oxide films that are prone to spallation and subsurface degradation of materials at high temperature as shown in FIG. 9a. Even significant amount of Al, which has been used to improve oxidation resistance of nickel based superalloys, could not slow down oxidation Amdry D15 comprising 3.5 wt. % Al.

Alternatively, brazing materials comprising titanium (Ti), zirconium (Zr), and hafnium (Hf) MDP with the chemical compositions shown in Table 2 could be used for manufacturing and repair of turbine engine components in lieu of boron and silicon based brazing materials.

TABLE 2
Chemical Composition of Ni—Ti Based Boron Free Brazing
Materials in wt. % with the Exception Specified in Notes*

| Patent/App No. | Ni | Co | Ti | Zr | Hf | Al | Si | Ta | Cr | Cu | Nb |
|---|---|---|---|---|---|---|---|---|---|---|---|
| U.S. Pat. No. 3,091,028* | Bal | — | 50 | — | — | — | 0.3 | — | — | — | — |
| | | | 55 | | | | 10 | | | | |
| U.S. Pat. No. 3,174,851 | Bal | — | 30 | — | — | — | — | — | — | — | — |
| | | | 50 | | | | | | | | |
| U.S. Pat. No. 3,662,455 | Bal | — | 22.8 | — | — | — | — | — | — | — | 20.7 |
| | | | 36.4 | | | | | | | | 50.3 |
| U.S. Pat. No. 6,149,051 | Bal | — | 25 | 15 | — | — | — | — | — | 10 | — |
| | | | 60 | 25 | | | | | | 25 | |
| U.S. Pat. No. 8,197,747 | Bal | 5.0 | 3.0 | 2.0 | 5.0 | 0 | — | — | 4.0 | | |
| | | 25 | 7.0 | 15 | 15 | 9 | | | 20 | | |
| WO2015/160523 | Bal | — | 7.0 | 10 | 18 | — | — | — | — | — | — |
| | | | 16.5 | 16 | 19.5 | | | | | | |
| WO2003/0049154 | — | — | Bal | — | — | — | 5.0 | — | 19.5 | — | — |
| | | | | | | | 27.5 | | 29.5 | | |

Note:
Content of chemical elements is provided from a min of ‘X’ wt. % to a max of Y’ wt. % and presented in the format, wherein a min of X wt. % is provided on the top and a max of Y wt. % is provided on the bottom.

However, there is still a need in the art for the development of boron free high temperature brazing materials for CB, WGB, LPM, and LB brazing.

### SUMMARY OF THE INVENTION

In one aspect, the specification relates to a nickel based brazing material comprising in weight percentages (wt. %) from 4.5 to 8.5% Cr, from 4.2 to 6.5% Ti, from 5.0 to 9.5% Zr, from 3.0 to 4.5% Hf, from 0.5 to 1.6% Ta, from 1.0 to 3.5% Al, from 0.5 to 2.0% Si, from 0 to 12.0% Fe, from 0 to 0.2% Mo, from 0 to 0.05% W, and Ni to balance. It was found such a nickel based brazing material produced sound joints and braze overlays with desirable mechanical and oxidation properties.

In one embodiment, the specification relates to a nickel based brazing material comprising in weight percentages (wt. %) from 4.5 to 8.5% Cr, from 4.2 to 6.5% Ti, from 5.0 to 9.5% Zr, from 3.0 to 4.5% Hf, from 0.5 to 1.6% Ta, from 1.0 to 3.5% Al, from 0.5 to 1.7% Si, from 0 to 12.0% Fe, from 0 to 0.2% Mo, from 0 to 0.05% W, and Ni to balance. It was found such a nickel based brazing material produced sound joints and braze overlays with desirable mechanical and oxidation properties.

In a second embodiment, the specification relates to a brazing material comprising in weight percentages (wt. %) from 6.0 to 8.0% Cr, from 6.0 to 6.5% Ti, from 9.0 to 9.5% Zr, from 4.0 to 4.5% Hf, from 1.4 to 1.6% Ta, from 3.0 to 3.5% Al, from 1.5 to 1.7% Si, from 0.05 to 0.2% Fe, and Ni to balance. It was found that such a nickel based brazing material produced sound joints and braze overlays with desirable mechanical and oxidation properties.

In a third embodiment, the specification relates to a brazing material comprising in weight percentages (wt. %) from 4.5 to 5.0% Cr, from 4.0 to 5.0% Ti, from 6.0 to 7.0% Zr, from 3.2 to 4.2% Hf, from 1.0 to 1.2% Ta, from 2.5 to 3.0% Al, from 1.0 to 1.2% Si, and Ni to balance. It was found that such a nickel based brazing material produced sound joints and braze overlays with desirable mechanical and oxidation properties.

In a fourth embodiment, the specification relates to a brazing material comprising in weight percentages (wt. %) from 5.0 to 6.0% Cr, from 4.2 to 4.8% Ti, from 5.0 to 6.0% Zr, from 3.0 to 3.5% Hf, from 1.0 to 1.2% Ta, from 2.5 to 3.0% Al, from 1.0 to 1.2% Si, from 5.0 to 6.0% Fe, and Ni to balance. It was found that such a nickel based brazing material produced sound joints and braze overlays with desirable mechanical and oxidation properties.

In a fifth embodiment, the specification relates to a brazing material comprising in weight percentages (wt. %) from 8.0 to 8.5% Cr, from 5.5 to 6.5% Ti, from 8.0 to 9.0% Zr, from 3.0 to 4.0% Hf, from 1.3 to 1.5% Ta, from 3.0 to 3.5% Al, from 1.4 to 1.5% Si, from 10.0 to 12.0% Fe, and Ni to balance. It was found that such a nickel based brazing material produced sound joints and braze overlays with desirable mechanical and oxidation properties.

In a sixth embodiment, the specification relates to a brazing material comprising in weight percentages (wt. %) from 4.6 to 5.0% Cr, from 4.3 to 4.5% Ti, from 6.3 to 6.5% Zr, from 3.2 to 3.4% Hf, from 0.5 to 0.8% Ta, from 1.0 to 2.0% Al, from 0.5 to 0.8% Si, from 0.05 to 0.02% Mo, from 0 to 0.05% W, and Ni to balance. It was found that such a nickel based brazing material produced sound joints and braze overlays with desirable mechanical and oxidation properties.

In a sixth embodiment, the nickel based active brazing material is selected from among powders, wires, ingots, shims, brazed joints, and repair areas of turbine engine components.

### BRIEF DESCRIPTION OF THE DRAWINGS

Reference will now be made, by way of example, to the accompanying drawings which show example embodiments of the present application, and in which:

FIG. 1 shows the microstructure of the LB200 brazing material embodiment formed during: (a) Casting into a water cooled copper chill; and (b) Furnace brazing followed by a slow cooling at a rate of 7° C. per minute;

FIG. 2 shows the microstructure of the LB250 brazing material embodiment formed during: (a) Casting into a water cooled copper chill; (b) Furnace brazing followed by a slow cooling at a rate of 7° C. per minute;

FIG. 3 shows the microstructure of the LB300 brazing material embodiment formed: (a) Casting into a water cooled copper chill; and (b) Furnace brazing followed by a slow cooling at a rate of 7° C. per minute;

FIG. 4 shows microstructure of the LPM layers depicting: (a) the boron diffusion layer of 1313 μm (1.31 mm) in thickness formed at 1205° C. in the nickel based H230 substrate during application of the standard LMP material comprising the Mar M247 filler and Amdry 775 brazing materials (M247-Amdry 775); (b) formation of voids along interface of the X40 cobalt based substrate at 1205° C. during application of the M247-Amdry 775 LMP material; and (c) formation of the diffusion layer of just 19.8-26.3 μm (0.0198-0.0263 mm) in thickness formed at 1240° C. in the X40 cobalt based substrate during application of the LMP material comprising Rene 80 filler and LB200 invented brazing materials;

FIG. 5 depicts the conventional butt brazed joints (CB) produced using LB200 brazing material at 1240° C. with soaking time of 60 minutes manufactured from: (a) 304 stainless steel; and (b) Haynes 230 (H230) nickel based solution strengthening material;

FIG. 6 shows the microstructure of the WGB brazed joints of 8 mm in width depicting: (a) the cross section of the tensile samples manufactured fractured through the H230 nickel based alloy that was joined using homogeneous LB250 brazing material; (b) the composite-like structure of the H230 WGB joint produced using homogeneous LB250 brazing material; and (c) the composite structure on the Rene 80 LPM joint produced using the dissimilar Rene 80 filler and LB200 brazing materials;

FIG. 7 shows the microstructure of the multi-layer braze overlay produced using: (a) the powder blend comprising 60 wt. % of Rene 142 filler and 40 wt. % of LB200 brazing powders; and (b) the LB250 brazing powder depicting the sound layers.

FIG. 8 shows a typical microstructure of: (a) the dissimilar Haynes 230 on the right and IN738 at the left produced using homogeneous LB300 brazing material depicting formation of the composite-like structure during brazing; (b) the LB300 braze layer on the IN738 substrate with the surfaces prepared for brazing by standard machining followed degreasing using isopropyl alcohol in lieu of FCP depicting excellent fluidity of an embodiment of the brazing material, disclosed herein.

FIG. 9 depicts oxidation of the test samples subjected to the cyclic oxidation testing at temperature of 1080° C. (1976° F.) for 500 hours, wherein: (a) the test sample manufactured from the commercially available Amdry D15 brazing material depicting the thickness of the surface oxide layer of 296.7 μm at the stage of spallation and subsurface layer of 347.7 μm affected by corrosion; and (b) the test sample manufactured from the LB250LT embodiment of an embodiment of the brazing material depicting thickness of the affected by oxidation surface layer of 37.2 μm and sound condition of the subsurface layer.

Similar reference numerals may have been used in different figures to denote similar components.

### Standard Acronyms

AMS—Aerospace Material Specification (standards)
ASTM—American Society for Testing and Materials (standards)
HAZ—Heat Affected Zone
HPT—High Pressure Turbine
LPT—Low Pressure Turbine
IGT—Industrial Gas Turbine Engines
NGV—Nozzle Gide Vane
UTS—Ultimate Tensile Strength
SEM—Scan Electron Microscopy
EDS—Energy-Dispersive X-ray Spectroscopy
DTA—Differential Thermal Analysis
PBHT—Post Braze Heat Treatment
LBW—Laser Beam Welding
GTAW—Gas Tungsten Arc Welding
MPW—Micro Plasma Welding
RW—Resistance Welding
FB—Furnace Brazing
LB—Laser Brazing
MPD—Melting Point Depressant
CB—Conventional Brazing
WGB—Wide Gap Brazing
LPM—Liburdi Powder Metallurgy Braze Infiltration Process, which is a variation of WGB
ABM—All Braze Material (sample)
FCP—Fluorocarbon Cleaning Process
RW—Resistance Welding
H230—Haynes 230, solution strengthening nickel based 230 alloy
IN738—Inconel 738, precipitation strengthening nickel based superalloy
R80—Rene 80, precipitation strengthening nickel based superalloy
R142—Rene 142, precipitation strengthening nickel based superalloy
GTD111—Precipitation strengthening nickel based superalloy
X40—Cobalt based alloy
304SS—Stainless steel, Type 304, iron based alloy
MCrAlY—Metal-Chromium-Aluminum-Yttrium protective coating

### Glossary

Superalloys—metallic materials with oxidation resistance and mechanical properties for service at elevated temperatures.

Austenite—Lettice with the face-centered cubic phase (fcc).

Gamma (γ) Phase—the continuous matrix (called gamma) is a fcc nickel-based austenitic phase that usually contains a high percentage of solid-solution elements such as Co, Cr, Mo, Re, and W.

Gamma Prime (γ′) Phase—the primary strengthening phase in nickel-based superalloys is a compound consisting of nickel and either aluminum or titanium Ni3Al or Ni3Ti that coherently precipitates in the austenitic γ matrix.

Polycrystalline Metals and Alloys—are materials comprising grains with different shape, size, and crystallographic orientation.

Directionally Solidified (DS) Materials—materials produced by casting wherein solidification starts at the walls of the casting and progresses perpendicularly from that surface into one direction.

Single Crystals (SC) Materials—are solid materials and articles in which an orderly three-dimensional arrangement of the atoms is repeated throughout the entire volume.

Base Material or Parent Material—one of the two or more metals or materials to be joined together to form a joint.

Borides—compounds consisting of two elements of which boron is the more electronegative one; boron form borides with metal and non-metal elements.

Intermetallic Compounds—is a type of metallic alloys that forms an ordered solid-state compound between two or more metallic elements. Intermetallic compounds are generally hard and brittle, with good high-temperature mechanical properties

Braze Defects—discontinuities that by nature or accumulated effect render a part or product unable to meet minimum applicable acceptance standards or specifications.

Liquation Crack—a crack in the weld that occurs during solidification and caused by the melting of low melting-point grain boundary constituents in combination with stresses.

Solidification Shrinkage—the volume contraction of a metal during solidification.

Dilution—the change in a chemical composition of braze or weld material caused by the interdiffusion of alloying element of brazing or weld and base materials along interface.

Brazing Material—the material to be added in making a brazed joint.

Furnace Brazing (FB)—is a thermal joining process wherein a brazing material is placed at or between the faying surfaces of articles to be joined or restored by an application of a brazing material onto the surface, and wherein articles are heated in vacuum or inert gases to melt the brazing material without melting of a substrate or a parent metals.

Conventional Brazing (CB)—is a thermal joining process wherein the articles to be joined by a furnace brazing are assembled with the clearance of 0.01-0.3 mm and wherein the brazing material is distributed between faying surfaces by the capillary actions.

Wide Gap Brazing (WGB)—is a thermal joining process wherein the articles to be joined or repaired by a furnace brazing are assembled with the clearance exceeding the width of 0.3 mm and as such cannot produce capillary forces for braze distribution. Therefore, to unable WGB brazing material is preplaced onto a join or repair areas.

Laser Brazing (LB)—is a thermal joining process wherein a brazing material and joint are heated by a laser beam with simultaneous application of melt by a laser beam brazing material without melting of a substrate or joint articles.

Laser Multi Pass Cladding—a braze buildup that is formed by two or more brazing passes utilizing cladding technique.

Laser Braze Pass—a single progression of a braze buildup on a substrate. The result of a braze pass is a braze bead or braze deposit.

Laser Braze Pool—the localized volume of molten braze material prior to its solidification as braze metal.

Wetting—is the ability of a liquid and particular a molten brazing material to maintain contact with a solid surface, resulting from of the substrate and liquid braze to interact when the two are brought together. The degree of wetting (wettability) is determined by a force balance between adhesive and cohesive forces.

Capillary Actions—is the process of a liquid flowing in narrow spaces without the assistance of, or even in opposition to, external forces like gravity.

Active Brazing—is a brazing process where in active metals such as titanium, zirconium, hafnium, and some others are added to the braze alloy for promoting of reaction and wetting of various metals and alloys comprising aluminum as well as ceramics by liquid brazing materials during brazing.

Gas Atomization—is the process of breaking bonds in a liquid ingot to obtain braze particle in gas phase.

Heat Treatment—the controlled heating and cooling processes used to change the structure of a material and alter its physical and mechanical properties.

Precipitation Heat Treatment or Hardening—the process of heating of alloys to a temperature at which certain elements precipitate, forming a harder structure, and then cooling at a rate to prevent return to the original structure.

Recrystallization—is a formation of a new, strain-free grain structure from existing one that usually accompanied by grain growth during heat treatment.

Recrystallization temperature—is an approximate temperature at which recrystallization of an existing grain structure occurs within a specific time.

Solution Heat Treatment—the heat treatment method that is used to heat alloys to a specific temperature for a certain period of time allowing one or more alloying elements to dissolve in a solid solution and then cool rapidly.

Brazing Powder—the brazing material in a form of powder that is added in making of brazing joints or clad braze build up in laser brazing.

Filler Powder—is usually the metal powder with the melting temperature exceeding melting temperature of brazing powder and as such the filler powder remain solid during furnace brazing (FB) but can be melted during laser brazing (LB).

Powder Blend—mix of at least two powders, wherein one is the brazing powder the second one is filler powder.

Brazing Wire—brazing material in a form of wire that is added in making of brazing joints or braze deposits.

Brazing Preform—brazing materials produced with the required shape and size by machining, casting, powder metallurgy or other means.

Optical microscopy, also referred to as a light microscopy (OM)—refers to a type of microscope that commonly uses visible light and a system of lenses to generate magnified images of small objects.

Scan Electron Microscopy (SEM)—refers to a type of electron microscope that produces images of a sample by scanning the surface with a focused beam of electrons.

Energy-dispersive X-ray spectroscopy (EDS)—is an analytical technique used for the elemental analysis or chemical characterization of a sample.

Ultimate Tensile Strength (UTS)—the resistance of a material to longitudinal stress, measured.

Yield Strength—the ability of a tested material to tolerate gradual progressive force without permanent deformation.

Ductility—ability of various materials, metals and alloys to be drawn, stretched, or formed without breaking.

Faying surfaces—are the contacting surfaces or faces of two similar or dissimilar materials preassembled to form a joint.

Fluorocarbon Cleaning Process (FCP)—process that is based on using of ions of fluoride gases as the active agent for preparing of nickel and cobalt based superalloys for braze repair by removing of various contaminants and aluminum oxides.

### DESCRIPTION OF EXAMPLE EMBODIMENTS

As was found by experiments, oxidation properties of known Ni—Ti based brazing materials even with low Ti content manufactured as per U.S. Pat. No. 8,197,747 (incorporated herein by reference) demonstrated low oxidation resistance when compared to Rene 80 base material as shown in Example 9. As such, there is a need in the art for the development of new boron free high temperature brazing materials for CB, WGB, LPM, and LB brazing.

An embodiment of an optimized amount of titanium (Ti), zirconium (Zr), and hafnium (Hf) MPD in a combination with aluminum (Al), chromium (Cr), tantalum (Ta), silicon (Si), iron (Fe), molybdenum (Mo), tungsten (W), and nickel (Ni) was used in the current invention to overcome weaknesses of standard brazing materials.

A gas atomizing in argon and helium can be used for manufacturing of brazing powders. The size of brazing powder particles can vary from 10 to 125 μm but is not limited by this range.

Commercially available sacrificial organic and water based binders premixed with brazing powders can be used for manufacturing of various brazing pasts and slurries for handling of turbine engine components and other articles prior to a furnace brazing. Brazing preforms and shims might be secured on a surface of turbine engine components using selected from among well-known LBW, GTAW, MPW or RW welding process or organic sacrificial adhesives such as 3M Super 77 glue.

Homogeneous brazing powders as well as powder blends comprising 25-50 wt. % of a commercially available high temperature nickel and cobalt based filler powders selected from among Rene 80, Rene 142, Mar M002, Mar M247, X-40, Hayne 188, and others with the brazing powder, disclosed herein, to balance can be used for LB, LPM, and WGB brazing.

The brazing embodiments shown in Table 3 were manufactured in accordance with the developed specifications for a characterization of brazed joints produced using the invented brazing material. The LB200 embodiment was manufactured by atomizing in argon of high purity to produce powder of 45 μm in diameter for furnace and laser brazing and braze overlay. In addition to above, the LB250, LB250F and LB300 brazing embodiments were manufactured by casting followed by machining of preforms to required geometries employing standard equipment and processes.

TABLE 3
Chemical Composition of Braze Material Embodiments (BME)
in wt. % to Balance and Solidification Range on Heating

| BME | Ni | Fe | Cr | Ti | Zr | Hf | Al | Si | Mo | W | Ta | Δ², ° C. |
|---|---|---|---|---|---|---|---|---|---|---|---|---|
| LB200 | Bal | 0.05 | 6.0 | 6.0 | 9.0 | 4.0 | 3.0 | 1.5 | 0 | 0 | 1.4 | 1120 |
| | | 0.2 | 8.0 | 6.5 | 9.5 | 4.5 | 3.5 | 1.7 | | | 1.6 | 1237.5 |
| LB250 | Bal | 0 | 4.5 | 4.0 | 6.0 | 3.2 | 2.5 | 1.0 | 0 | 0 | 1.0 | 1160 |
| | | | 5.0 | 5.0 | 7.0 | 4.0 | 3.0 | 1.2 | | | 1.2 | 1190 |
| LB250LT | Bal | 0 | 4.6 | 4.3 | 6.3 | 3.2 | 1.0 | 0.5 | 0.05 | 0 | 0.5 | 1130 |
| | | | 5.0 | 4.5 | 6.5 | 3.4 | 2.0 | 0.8 | 0.2 | 0.05 | 0.8 | 1180 |
| LB250F | Bal | 5.0 | 5.0 | 4.2 | 5.0 | 3.0 | 2.5 | 1.0 | 0 | 0 | 1.0 | 1170 |
| | | 6.0 | 6.0 | 4.8 | 6.0 | 3.5 | 3.0 | 1.2 | | | 1.2 | 1230 |
| LB300 | Bal | 10.0 | 8.0 | 5.5 | 8.0 | 3.0 | 3.0 | 1.4 | 0 | 0 | 1.3 | 1118 |
| | | 12.0 | 8.5 | 6.5 | 9.0 | 4.0 | 3.5 | 1.5 | | | 1.5 | 1233 |

Note:
¹Content of chemical elements is provided from a min of X wt. % to a max of Y wt. % and presented in the format, wherein a min of X wt. % is provided on the top and a max of Y wt. % is provided at the bottom.
Δ²—solidification range

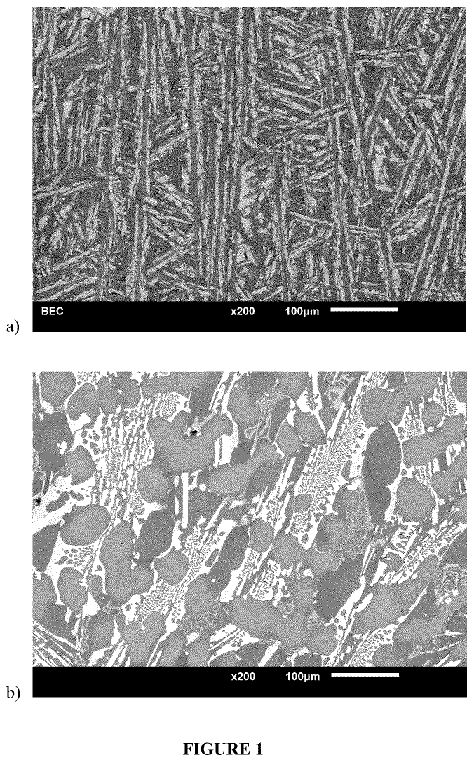

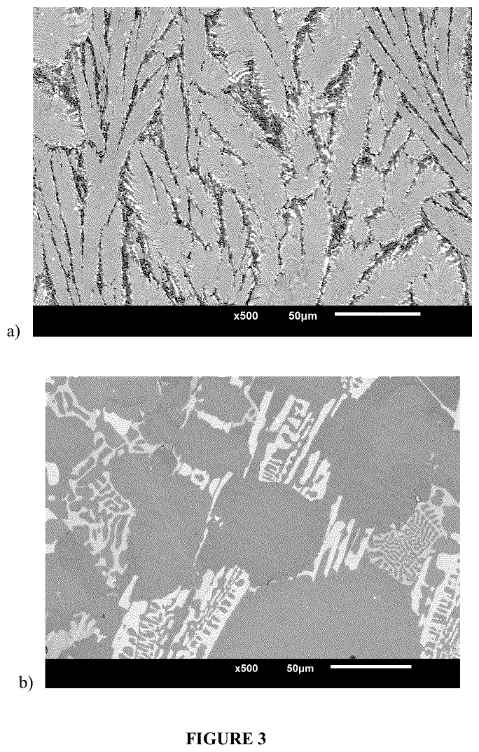

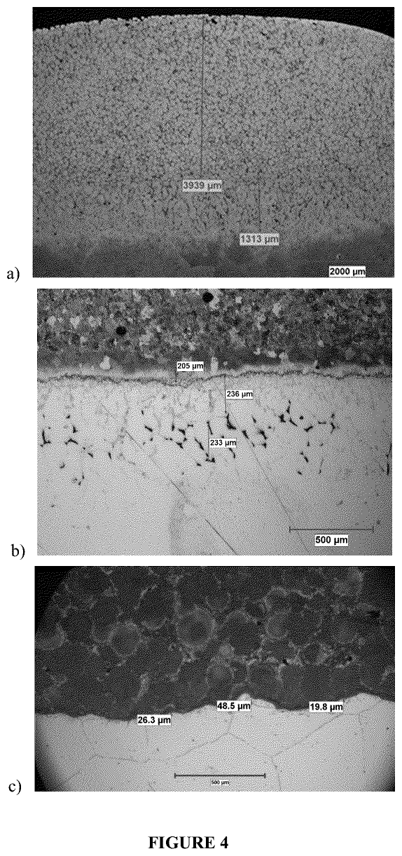

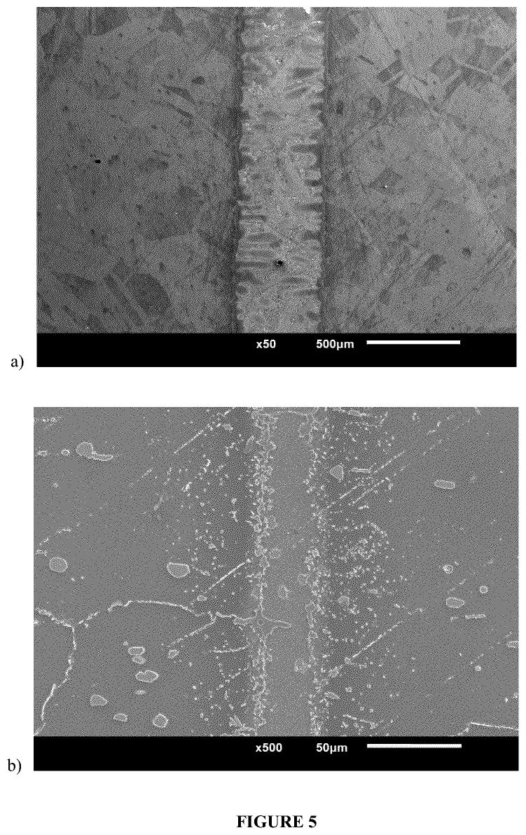

As it was fond by experiments, rapid cooling of brazing embodiments during casting into a water cooled copper mould resulted in a formation of a dendritic structure shown in FIGS. 1a, 2a, and 3a while soaking at a brazing temperature followed by furnace cooling resulted in a formation of a novel composite-like structure comprising powder-like compounds impinged into a braze matrix as shown in FIGS. 1b, 2b, and 3b due to isothermal solidification, which distinguished the developed brazing material from known LPM and WGB materials wherein a composite structure shown in FIGS. 4c and 5c was formed as a result of the infiltration of dissimilar high temperature filler powders by low temperature brazing materials.

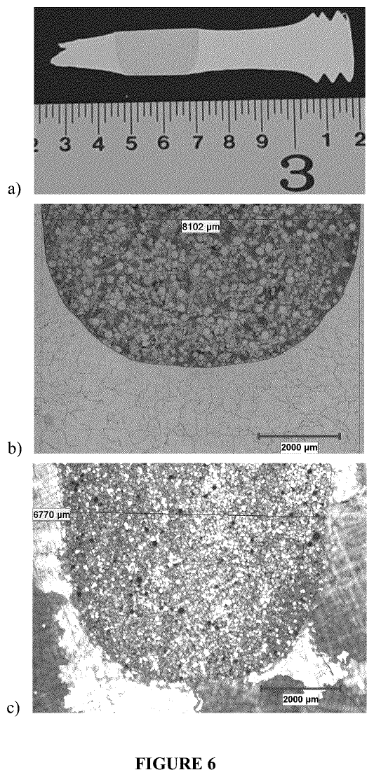

Formation of the novel composite-like structure by the brazing material, disclosed herein, enabled WGB without high temperature filler powders as shown in FIG. 6b. However, if required the brazing material, disclosed herein, in combination with high temperature filler powders can be used also for standard WGB and LPM as shown in Examples 5 and 6.

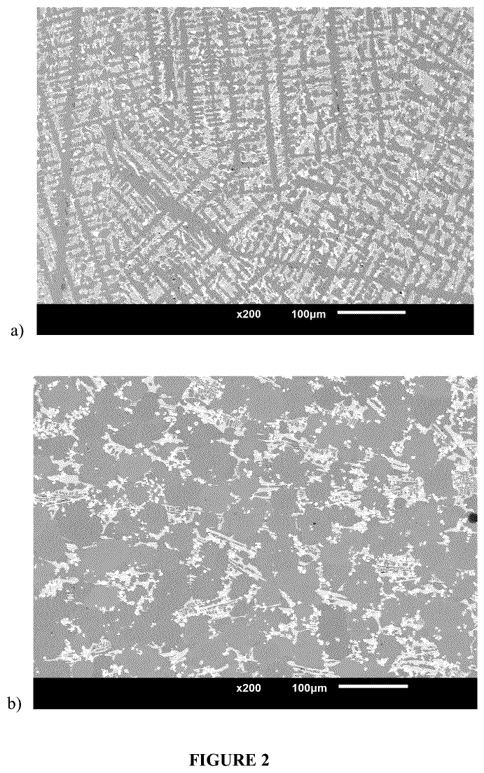

It was found by experiments the WGB joints produced using the homogeneous welding material, disclosed herein, were less prone to porosity than LPM joints produced using dissimilar filler and brazing powders as shown in FIG. 6b and FIG. 6c respectively. Also, as it was found by experiments, the brazing material, disclosed herein, did not produce voids adjacent to the interface with the cobalt based X-40 alloy, which was typical for brazing of Co alloys using standard boron bearing brazing material as shown in FIG. 4b. Substitution of Amdry 775 with LB250 reduced the thickness of a diffusion layer in solution strengthening H230 nickel alloy from 1313 μm to 211.994 μm respectively. Very thin diffusion layers in comparison with the width of brazed joints were formed also in iron and various nickel based alloys as shown in FIGS. 2a, 3b, 5, 6b, 6c, and 7.

The temperature for furnace brazing (FB) is selected based on liquidus and solidus temperature of braze embodiments, chemical composition of base materials, and joint design. For example, FB for CB joints and LPM of aluminum bearing superalloys utilizing infiltration of brazing material through the pre-sintered in the solid state filler powders should be performed at temperatures exceeding liquidus temperature of the selected brazing embodiment but below of the solidus temperature of a base material that can be found either from various handbooks or established by experiments using DTA. WGB of solution strengthening iron, nickel, and cobalt based alloys can be performed just near to the liquidus temperature.

For characterization of tensile properties of butt CB, WGB, and LPM joints samples were extracted in transvers direction with the brazed joint located at the center of the gage area. The “All Braze Metal” (ABM) samples were extracted from the U-groove joints of ≥6 mm in width in the axial direction. Tensile samples were manufactured as per ASTM E-8 and tested at 927° C. (1700° F.) as per ASTM E-21 in air.

The oxidation properties of the brazing embodiments disclosed herein, as well as Rene 80 base materials and brazing material as per cited patent U.S. Pat. No. 8,197,747 (further marked '747) (incorporated herein by reference) were evaluated by a cyclic oxidation testing in air at 1120° C. (2048° F.). Test temperature was selected to simulate maximum temperature of turbine engine components of aero turbine engines during takeoff. Usually, takeoff last up to 90 seconds. In cruise conditions the temperature of HPT components does not exceed 850° C. (1562° F.). Therefore, to speed up oxidation testing each cycle included exposure of test samples to 1120° C. (2048° F.) in still air for 50 min followed by rapid cooling ≤400° C. and reheating back to 1120° C. (2048° F.) in total for 10 minutes. The cyclic oxidation testing last for 100 cycles. Oxidation resistance was measured as weight loss per square inch of the surface (Δ gram/in²). The braze embodiments with the oxidation resistance superior or similar to Rene 80 were considered for manufacturing and repair of aero turbine engine components while the braze embodiments with the oxidation resistance below of Rene 80 were recommended for manufacturing and repair of turbine engine components of IGT engines, which do not exercise takeoff conditions, in a combination with well-known MCrAlY, Pt, and aluminide protective coatings.

In addition to above, the cyclic oxidation testing of the LB250LT braze material embodiment and commercially available aluminum bearing Amdry D15 brazing material was conducted for 500 cycle in air. It was believed that Amdry D15 should have better oxidation resistance than other commercially available brazing materials shown in Table 1 due to high Al content. The cycle comprised exposure of test samples to 1080° C. (1976° F.) in still air for 50 min followed by rapid cooling ≤400° C. (752° F.) and reheating back to 1080° C. (1976° F.) in total for 10 minutes. The oxidation resistance of each material was evaluated by measuring the thickness of oxidation layer and subsurface layer affected by oxidation.

### Example 1

Samples manufactured from H230 nickel based solution strengthening alloy of 10 mm in thickens were subjected to furnace brazing in vacuum of ≤5·10⁻⁵ torr at temperature of 1240° C. (2254° F.) with soaking time of 15±5 min followed by heat treatment to age the brazed joint at 900° C. (1652° F.) for 4 hours. The faying surfaces were secured by GTAW welding with the clearance of ≤0.2 mm prior to brazing. The brazing past manufactured from LB200 brazing powders and organic binder was applied onto the joint line and dried at 160° C. (320° F.) for 2 hours in the air circulated oven. The LB250, LB250F, and LB300 braze preforms were secured on the top of the joints by resistance welding. After brazing joints were subjected to the standard radiographic and metallographic examination. The tensile samples were manufactured from the butt brazed joints. Tensile testing was performed at 927° C. (1700° F.). The brazed joints were located at the center of the gage area. The typical microstructure of brazed joints is shown in FIGS. 5a and 5b. Tensile properties of the CB joints are provided in Table 4.

TABLE 4
Tensile Properties of Haynes 230 (H230) Butt Brazing
Joints (BJ) at 927° C. (1700° F.)

| | UTS, MPa | Elongation, |
|---|---|---|
| Material | (KSI) | % |
| H230 Base Material | 224.1 (32.5) | 50.6 |
| H230 LB200 BJ | 227.5 (33.0) | 42.7 |
| H230 LB250 BJ | 221.3 (32.1) | 43.5 |
| H230 LB250LT BJ | 228.0 (33.1) | 42.1 |
| H230 LB250F BJ | 222.5 (32.3) | 44.0 |
| H230 LB300 BJ | 217.2 (31.5) | 41.7 |

As follows from Table 4, UTS of brazed joints produced using all developed braze embodiments was similar to UTS of the base material. Brazed samples demonstrated excellent ductility with elongation exceeding of 40%. Metallographic examination and EDS analysis did not reveal degradation of the base material along the braze interface as well as extensive diffusion of titanium and other active alloying elements into the base material as shown in FIGS. 5a and 5b.

### Example 2

Samples manufactured from the austenitic 304 stainless steel were secured by GTAW welding with the clearance of 0.5 mm to produce the WGB butt joint. The furnace brazing was performed using LB200 brazing material in vacuum ≤5.10″5 torr at temperature of 1230° C. (2246° F.). The same brazing parameters were used to seal the opening in the 304 stainless steel of 6.5 mm in dimeter. Distribution of brazing material in the brazing area was driven by gravity and surface tension. High viscosity of the brazing material in the solid-liquid condition prevented escaping of the brazing material from the brazing area. The soaking time was 60 min followed by cooling at a rate of 7° C. per min. After brazing samples were subjected to heat treatment at 1080° C. (1976° F.) for 4 hours.

TABLE 5
Tensile Properties of 304 Stainless Steel (304SS) Butt Brazing
Joints (BJ) at 927° C. (1700° F.)

| | UTS, MPa | Elongation, |
|---|---|---|
| Material | (KSI) | % |
| 304SS Base Material | 88.9 (12.9) | 50.2 |
| 304SS LB200 BJ | 91.0 (13.2) | 44.6 |

After standard radiographic inspection, the transvers sample manufactured from the butt brazed joint and base material were subjected to tensile testing at 927° C. (1700° F.). Brazed joints demonstrated exceptional ductility with the elongation and strength similar to the base material as shown in Table 5. The microstructure of the brazed joint shown in FIG. 5a depicts formation of the defect free joint with the insignificant diffusion layer.

### Example 3

The cobalt based X-40 CB joint with the clearance of 0.15-0.2 mm in width was produced using LB200 brazing material in vacuum ≤5·10⁻⁵ torr at 1240° C. (2264° F.) and soaking time of 15 min followed by furnace cooling at a rate of 7° C. per min. After brazing tensile samples were subjected to heat treatment at 1080° C. (1976° F.) for 4 hours. Transvers tensile samples were manufactured from the brazed joint and subjected to radiographic examination. No cracks were found. As shown in Table 6 base material and brazed joints demonstrated similar UTS.

TABLE 6
Tensile Properties of Cobalt Based X40 Butt Brazed
Joint (BJ) at 927° C. (1700° F.)

| Material | UTS, MPa (KSI) | Elongation, % |
|---|---|---|
| X40 Base Material | 299.2 (43.4) | 73.1 |
| X40 LB200 BJ | 303.4 (44.0) | 48.5 |

### Example 4

WGB joints of Haynes 230 of 6.3-6.7 mm in width and 8 mm in depth were produced in blankets of 15 mm in thickness to demonstrated WGB using LB250 brazing material. WGB was performed in vacuum ≤5·10⁻⁵ torr at 1220° C. (2228° F.), which was 30° C. above of the liquids temperature of LB250, and soaking time of 60 minutes followed by aging heat treatment of the WGB material at 1080° C. (1976° F.) for 4 hours and 843° C. (1550° F.) for 16 hours.

TABLE 7
Tensile Properties of Haynes 230 and WGB Joints (WGBJ) MPa

| | | | | 0.2% | |
|---|---|---|---|---|---|
| | Temp. | | | Yield | |
| | ° C. | | UTS, MPa | Strength, | |
| Material | (° F.) | | (KSI) | MPa (KSI) | Elong. % |
| H230 | 20 | (70° F.) | 766.7 (111.2) | 308.2 (44.7) | 42.0 |
| Base Material | 927 | (1700° F.) | 249.6 (36.2) | 152.4 (22.1) | 40.4 |
| H230 WGBJ | 20 | (70° F.) | 782.6 (113.5) | 335.8 (48.7) | 29.5 |
| | 927 | (1700° F.) | 231.1 (33.5) | 182.7 (26.5) | 56.5 |

Brazed joints demonstrated UTS similar to the base material as shown in Table 7. However, fracture of brazed joints took place through the base material as shown in FIG. 6a due to superior strength of the LB200 brazing material. Isothermal solidification followed by slow cooling at the rate of 7° C. per minute resulted in a formation of the composite-like structure shown in FIG. 6b, which was found to be similar to the composite structure formed by dissimilar LB200 brazing material and Rene 80 filler powder, which remained in the solid condition during brazing as shown in FIG. 6c. Hence, morphology of a microstructure of WGB joints produced by homogenous LB200 and dissimilar Rene 80-LB200 materials were similar.

### Example 5

The LPM U-groove joints of 6.3-6.7 mm in width and 7 mm in depth were produced in the Rene 80 blankets of 10 mm in thickness to demonstrated the braze infiltration of the Rene 80 filler powder by the LB200 brazing material and formation of sound joints.

The U-groove was filled up with the filler powder putty manufactured from 96 wt. % of Rene 80 powder of 45-75 μm in diameter and 4 wt. % of a commercially available organic binder. The braze pasts comprising 94 wt. % of LB200 brazing powders premixed with the commercially available organic binder was applied uniformly onto the top of the filler powder putty with the ratio of 3.8 grams of braze per 10 grams of filler powder putty. The prepared samples were subjected to drying in the air forced oven at 180° C. (1976° F.) for 4 hours aiming to remove volatile elements from the binder and solidify the filler powder putty and braze pasts. Brazing of samples was performed in vacuum ≤5·10⁻⁵ torr. Brazing temperature of 1240° C. (2264° F.) was selected above the liquidus temperature LB200 brazing materials of 1237° C. (2259° F.) to allow infiltration of the liquid brazing materials through the sintered in the solid state during heating porous Rene 80. The 2 hours long diffusion cycle was used to enhance the inter-diffusion of alloying elements between base materials, filler powder particle, and brazing materials followed by slow cooling at the rate of 7° C. per min to 900° C. (1652° F.) and argon quench to ambient temperature. The brazed samples were subjected to primary aging at 1080° C. (1976° F.) for 4 hours followed by secondary aging at 843° C. (1550° F.) for 16 hours that resulted in precipitation of strengthening gamma prime phase in base and brazing materials comprising high amount of Al and Ti gamma prime forming elements. Transvers tensile samples with the LPM joints situated at the center of the gage area and longitudinal ABM samples from the LPM material were manufactured as per ASTM E-8. Samples were subjected to tensile testing at 927° C. (1700° F.) after standard radiographic examination, which did not revile cracks in the LPM material. The microstructure of the brazing joints shown in FIG. 6c depicts formation of the composite structure comprising Rene 80 filler powder particles impinged into the matrix produced by LB200 brazing materials.

TABLE 8
Tensile Properties of Rene 80 (BM) and WGB Joints
at 927° C. (1700° F.)

| | | 0.2% Yield | |
|---|---|---|---|
| | UTS, MPs | Strength, MPa | Elongation, |
| Material | (KSI) | (KSI) | % |
| BM | 595.0 (86.3) | 425.4 (61.7) | 14.5 |
| WGB joints produced | 484.7 (70.3) | 373.7 (54.2) | 5.3 |
| by LB200 braze | | | |
| ABM produced by | 546.1 (79.2) | 340.6 (49.4) | 3.6 |
| LB200 braze | | | |

As follows form Table 8, tensile properties of LPM joints as well as All Braze Material (ABM) produced by Rene 80 filler powder that was infiltrated by LB200 brazing material were superior to tensile properties of joints produced using boron based Amdry DF-3 brazing material and Mar M247 filler powder of 340 MPa (49.3 KSI) at 927° C. (1700° F.) that were reported by R. Sparling et al “Liburdi Powder Metallurgy, Application for Manufacture and Repair of Gas Turbine Components”, Sixth International Charles Parson Turbine Conference, Dublin, Ireland, Sep. 16-18, 2003, pp. 987-1005 (incorporated herein by reference).

### Example 6

To demonstrate that other then Rene 80 filler powders can be used for WGB and LPM, the IN738 U-groove joints of 6.3-6.7 mm in width and 7 mm in depth were produced in blankets of 10 mm in thickness using the Rene 142 filler powder with LB200 brazing material. The U-groove was filled up with the filler powder putty manufactured from 96 wt. % of Rene 142 powder of 45 μm in diameter and 4 wt. % of a commercially available organic binder. The braze past comprising 94 wt. % of LB200 brazing powder premixed with the commercially available organic binder was applied uniformly onto the top of the filler powder putty with the ratio of 4.0 grams of braze per 10 grams of filler powder. Prepared samples were subjected to drying in the air forced oven at 180° C. for 4 hours aiming to remove volatile elements from the binder and solidify the filler powder putty and braze pasts. Brazing of samples was performed in vacuum ≤5·10⁻⁵ torr. Brazing temperature of 1240° C. (2264° F.) was selected just above the liquidus temperature of LB200 brazing material to allow infiltration of the sintered in the solid state during heating porous Rene 142 filler powder by liquid brazing material. The one hour long diffusion cycle was used to enhance the inter-diffusion of alloying elements between IN738 base material, Rene 142 filler powder, and LB200 brazing material followed by slow cooling with the rate of 7° C. per min to 900° C. (1652° F.) in vacuum and argon quench to ambient temperature. To restore properties of the base material that exercised full annealing during brazing cycles, brazed samples were subjected to the primary aging at 1120° C. (2048° F.) for 2 hours followed by the secondary aging at 843° C. (1550° F.) for 24 hours that resulted in precipitation of high strength gamma prime phase in base and brazing materials comprising high amount of Al and Ti gamma prime forming elements. After standard radiographic examination that confirmed formation of defect free joints, samples were subjected to tensile testing at 927° C. (1700° F.).

TABLE 9
Tensile Properties of IN738 (BM) and WGB Joints
at 927° C. (1700° F.)

| | Ultimate | 0.2% Yield | |
|---|---|---|---|
| | Tensile | Strength, | Elongation, |
| Material | Strength, KSI | KSI | % |
| IN738 BM | 586.1 (85.0) | 429.5 (62.3) | 13.8 |
| IN738 WGB Joints | 561.2 (81.4) | 445.4 (64.6) | 14.2 |

As follows from Table 9, the IN738 base material and LPM joints demonstrated similar UTS and elongation. High elongation of brazed joints most likely was attributed to the elevated 0.2% yield strength of LPM material that enable accommodation of stresses by plastic deformation of more ductile base material prior to fracture.

### Example 7

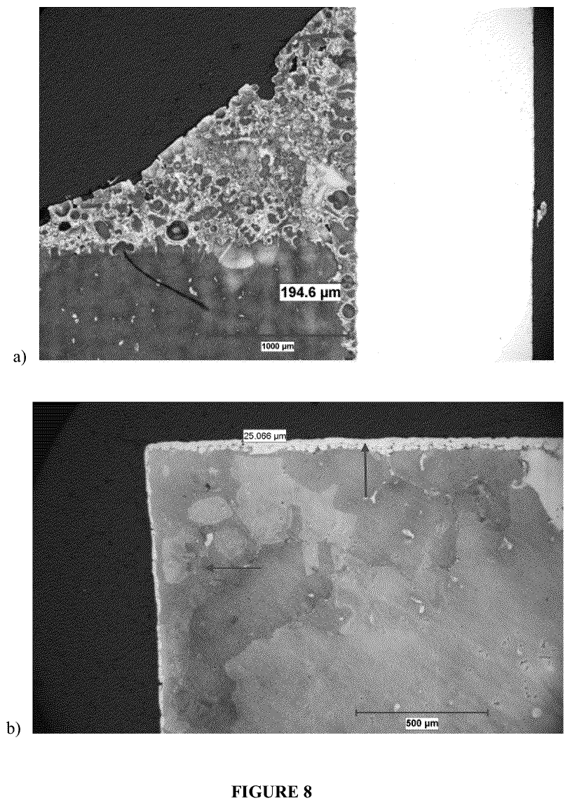

For a demonstration of brazing of dissimilar materials, the H230 strip of 1.2 mm in thickness was brazed to the IN738 plate of 10 mm in thickness as shown in FIG. 8a, right and left sides respectively. In addition to above, for characterization of high temperature tensile properties of H230-IN738 dissimilar butt brazed joints (H230-IN738 BJ) was produced using LB300 brazing preforms.

TABLE 10
Tensile Properties of LB300 brazing Material,
Base Materials (BM) and Brazed Joint (BJ)

| | Temperature, | | | | |
|---|---|---|---|---|---|
| | ° C. | | UTS, MPa | | Elongation, |
| Material | (° F.) | | (KSI) | | % |
| Haynes 230 BM | 20 | (70) | 453 | (65.6) | 36.5 |
| | 927 | (1700) | 249.6 | (36.2) | 40.4 |
| IN738 BM | 20 | (70) | 968.3 | (140) | 5.2 |
| | 927 | (1700) | 586.1 | (85.0) | 13.8 |
| H230-IN738 BJ | 20 | (70) | 463.3 | (67.3) | 16.4 |
| | 927 | (1700) | 253.7 | (36.8) | 19.5 |
| LB300 Ingot | 20 | (70) | 968.1 | (140.5) | 2.9 |
| | 927 | (1700) | 484.0 | (70.2) | 5.8 |

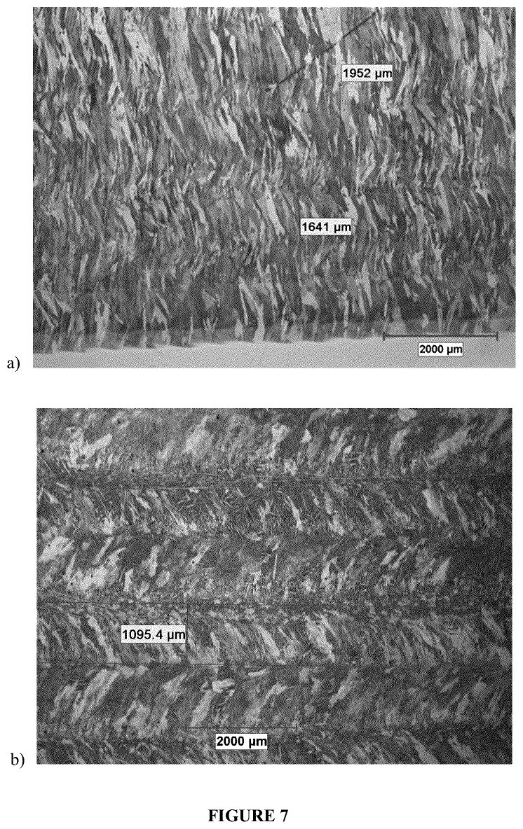

Prior to brazing samples were assembled with the clearance approximately of 0.2 mm (200 μm) as shown in FIG. 8a and secured using standard GTAW tack welding. Brazing preforms were secured on the surface of brazed joints using resistance spot welding. Brazing of samples was performed in vacuum ≤5·10⁻⁵ torr at 1240° C. (2064° F.) with the soaking time of 60 min. To restore properties of the base material that exercised annealing during brazing cycles, brazed samples were subjected to the primary aging at 1120° C. (2048° F.) for 2 hours followed by the secondary aging at 843° C. (1550° F.) for 24 hours prescribed for IN738. Metallographic examination reviled formation of a composite-like structure as shown in FIG. 7a.

Tensile properties of dissimilar brazed joints were at the level of H230 base material as shown in Table 10. Fracture of dissimilar brazed joints took place through the low strength solution strengthening H230 base material due to superior tensile strength of LB300 brazing material and IN738 precipitation strengthening superalloy.

### Example 8

The 40 wt. % of LB200 brazing and 60 wt. % of Rene 142 filler powder blend, further 40LB200/60R142, which was also typically used for furnace WGB, was used to demonstrated the multi pass laser overlay. The powder blend was prepared using a standard V-shaped mixer. The LB200 brazing and R142 filler powders were blended for 4 hour aiming to produce uniform powder blend.

For conducting tensile testing of the braze overlay, fabrication of specimens up to 120 mm in length by 25 mm in width and 3 mm thickness was required. As such, fabrication of specimens for tensile testing was done using the LAWS1000 automated laser welding system equipped with 1 kW continues wave fiber Ytterbium IPG Photonic laser by multi pass LB cladding. Laser beam and coaxial conical stream of powder particles were focused on the surface of the GTD111 substrate and consecutive braze layers. The dissimilar 40LB200/60R142 powder blend was fully melted forming homogeneous brazing pool then produced sound multi layers braze deposits during cooling.

The laser braze overlay was performed using following parameters: a laser head speed of 1.5 mm/s, a laser beam power of 380 W focused to a spot size of 500 μm, and a powder feed rate of 3.8 g/min. The laser head was oscillated in a transfer direction with the speed of 10 mm/s and amplitude of 1 mm to produce braze deposited of 2.5-3 mm in width. Metallographic evaluation of multi layer deposits reviled formation of a crack free directionally solidified due to epitaxial grain growth structure shown if FIG. 7a. After LB fabricated samples were subjected to post fabrication heat treatment prescribed for the heat treatment of the GTD111 superalloy that composed the primary aging at 1120° C. (2048° F.) for 2 hours followed by the secondary aging at 843° C. (1550° F.) for 24 hours.

After machining, the fabricated samples were subjected to standard radiographic inspection that confirmed formation of the crack free braze deposits and sound interface with the base material.

TABLE 11
Tensile Properties of the Multi Pass Lase 40LB200-60R142
Braze Deposit at 982° C. (1800° F.)

| | | 0.2% Yield | |
|---|---|---|---|
| | UTS, MPa | Strength, MPa | Elongation, |
| Material | (KSI) | (KSI) | % |
| 40LB200-60R142 | 334.4 (48.5) | 226.1 (32.8) | 12 |

Combination of high strength and ductility of materials produced by LB shown in Table 11 enabled application of 40LB200-60R142 powder blend for structural repair of turbine engine components and tip repair of HTP and LPT blades of aero and IGT engines.

In addition to above, the multilayer layer braze overlay was produced using homogeneous LB250 brazing powder to demonstrate capabilities of the invented material to form sound braze overlay utilizing commercially available laser welding equipment. The microstructure of the multi layer LB250 multi layer braze overlay is shown in FIG. 7b.

### Example 9

As shown in Table 12, the cyclic oxidation resistance of brazing embodiments of the invented brazing material at 1120° C. (2048° F.) was superior to the '747 brazing material described in the U.S. Pat. No. 8,197,747 cited patent. Furthermore, oxidation resistance of the LB300 brazing embodiment was at the level of the Rene 80 braze material.

TABLE 12
Cyclic Oxidation Resistance of Brazing Embodiments and Rene 80 Base Material at 1120° C. (2048° F.)
Weight Loss, Δ gram/in²

| Rene 80 | ′747 | LB200 | LB250 | LB250F | LB300 |
|---|---|---|---|---|---|
| −0.0538 | −0.3584 | −0.3244 | −0.0751 | −0.1258 | −0.0523 |

### Example 10

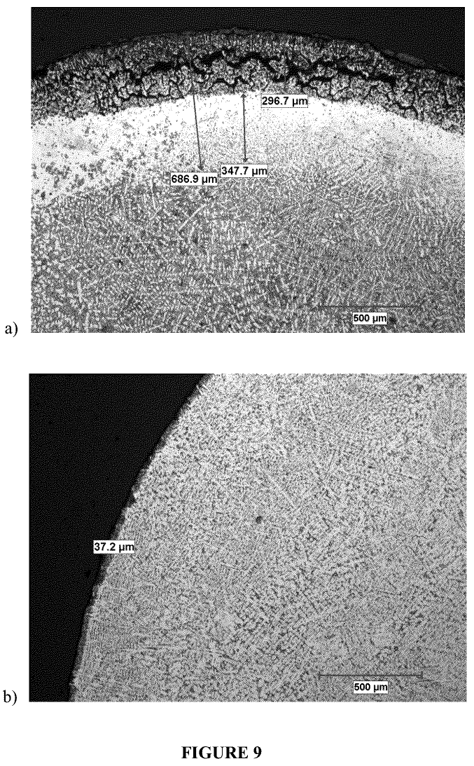

Metallographic examination of LB250LT and Amdry D15 test samples subjected to the cyclic oxidation testing at 1080° C. (1976° F.)↔400° C. (752° F.) for 500 cycles reviled that thickness of the oxides on the surface of the sample D15 at stage of spallation was 296.7 μm and subsurface layer effected by oxidation was 347.7 μm while the thickness of the oxidation layer on the LB250LT sample was just 37.2 μm as shown in FIGS. 9a and 9b respectively. No subsurface layer affected by oxidation of the LB250LT sample was fund demonstrating superiority of the invented brazing material over commercially available brazing material discussed above.

The superior technological, mechanical, and oxidation properties of embodiments of the invented brazing material were achieved by the unique combination of alloying elements, where each alloying element plaid unique non-obvious role in a formation of the novel structure and superior properties. For example, silicon, which was used in prior arts mostly as the melting point depressant, in a combination with Hf and Ta contributed to increasing of the liquidus temperature of the LB200 embodiment to 1237° C. (2259° F.) when compared to the LB250 with the liquidus temperature of 1190° C. (2174° F.) as shown in Table 3. This phenomenon was attributed to a formation of refractory Ta, Hf, and Mo based silicide in lieu to forming of low melting point nickel based silicide.

The invented active brazing materials demonstrated excellent wetting of aluminum and chromium bearing superalloys due to interaction of Ti, Zr, and Hf with surface oxides enabling substitution of environmentally and health hazardous pre-braze FCP cleaning process with standard machining and degreasing.

High strength of the invented brazing material was attributed to a formation of the novel composite-like structure during brazing, formation of Al and Ti based gamma prime phase during post braze aging heat treatment, and solid solution strengthening on the nickel based matrix by Cr, Ta, and Fe. Iron also enhanced fluidity and ductility. In addition to above, iron in a quantity of 10-12 wt. % significantly increased oxidation resistance of the invented brazing material while in standard iron free high gamma prime nickel based superalloys such as Inconel 738, Mar M247, Rene 80, and Rene 142 iron is considered just as an impurity.

Based on the solidification range, fluidity, mechanical and oxidation properties as well as joint design, the LB200 and LB300 embodiments were recommended preferentially for sealing of holes, dents, restoration of airfoil thickness, laser brazing, and WGB. The LB250 and LB250F embodiments are preferential for the conventional brazing and LPM by the infiltration of the pre-sintered in a solid state filler powders with the invented brazing material, as well as for laser brazing and overlay utilizing various powder blends. It should be noted that the current invention is not limited to the described braze material embodiments and examples. Other embodiments with the scope of the current invention can be manufactured by those skilled in the art.

Certain adaptations and modifications of the described embodiments can be made. Therefore, the above discussed embodiments are considered to be illustrative and not restrictive.

What is claimed is:

1. A nickel based active brazing material comprising of the following chemical elements in weight percentages (wt. %):

| | |
|---|---|
| Chromium | from 4.5 to 8.5%, |
| Titanium | from 4.2 to 6.5%, |
| Zirconium | from 5.0 to 9.5%, |
| Hafnium | from 3.0 to 4.5%, |
| Tantalum | from 0.5 to 1.6%, |
| Aluminum | from 1.0 to 3.5%, |
| Silicon | from 0.5 to 1.7%, |
| Iron | from 0 to 12.0%, |
| Molybdenum | from 0 to and 0.2%, |
| Tungsten | from 0 to 0.05%, and |
| Nickel to balance. | |

2. The nickel based active brazing material as per claim 1 comprising of the following chemical elements in weight percentages (wt. %):

| | |
|---|---|
| Chromium | from 6.0 to 8.0%, |
| Titanium | from 6.0 to 6.5%, |
| Zirconium | from 9.0 to 9.5%, |
| Hafnium | from 4.0 to 4.5%, |
| Tantalum | from 1.4 to 1.6%, |
| Aluminum | from 3.0 to 3.5%, |
| Silicon | from 1.5 to 1.7%, |
| Iron | from 0.05 to 0.2%, and |
| Nickel to balance. | |

3. The nickel based active brazing material as per claim 1 comprising of the following chemical elements in weight percentages (wt. %):

| | |
|---|---|
| Chromium | from 4.5 to 5.0%, |
| Titanium | from 4.0 to 5.0%, |
| Zirconium | from 6.0 to 7.0%, |
| Hafnium | from 3.2 to 4.0%, |
| Tantalum | from 1.0 to 1.2%, |
| Aluminum | from 2.5 to 3.0%, |
| Silicon | from 1.0 to 1.2%, and |
| Nickel to balance. | |

4. The nickel based active brazing material as per claim 1 comprising of the following chemical elements in weight percentages (wt. %):

| | |
|---|---|
| Chromium | from 5.0 to 6.0%, |
| Titanium | from 4.2 to 4.8%, |
| Zirconium | from 5.0 to 6.0%, |
| Hafnium | from 3.0 to 3.5%, |
| Tantalum | from 1.0 to 1.2%, |
| Aluminum | from 2.5 to 3.0%, |
| Silicon | from 1.0 to 1.2%, |
| Iron | from 5.0 to 6.0%, and |
| Nickel to balance. | |

5. The nickel based active brazing material as per claim 1 comprising of the following chemical elements in weight percentages (wt. %):

| | |
|---|---|
| Chromium | from 8.0 to 8.5%, |
| Titanium | from 5.5 to 6.5%, |
| Zirconium | from 8.0 to 9.0%, |
| Hafnium | from 3.0 to 4.0%, |
| Tantalum | from 1.3 to 1.5%, |
| Aluminum | from 3.0 to 3.5% |
| Silicon | from 1.4 to 1.5%, |
| Iron | from 10.0 to 12.0%, and |
| Nickel to balance. | |

6. The nickel based active brazing material as per claim 1 comprising of the following chemical elements in weight percentages (wt. %):

| | |
|---|---|
| Chromium | from 4.6 to 5.0%, |
| Titanium | from 4.3 to 5.5% |
| Zirconium | from 6.3 to 6.5%, |
| Hafnium | from 3.2 to 3.4%, |
| Tantalum | from 0.5 to 0.8%, |
| Aluminum | from 1.0 to 3.5%, |
| Silicon | from 1.0 to 2.0%, |
| Molybdenum | from 0. to 0.2%, |
| Tungsten | from 0 to 0.05, and |
| Nickel to balance. | |

7. The nickel based active brazing material according to claim 1, wherein the nickel based active brazing material is selected from among a powder, a wire, an ingot, a shim, a turbine engine component with a brazed joint or a repair area of the turbine engine component made from the nickel based active brazing materials.

8. The nickel based active brazing material according to claim 2, wherein the nickel based active brazing material is selected from among a powder, a wire, an ingot, a shim, a turbine engine component with a brazed joint or a repair area of the turbine engine component made from the nickel based active brazing materials.

9. The nickel based active brazing material according to claim 3, wherein the nickel based active brazing material is selected from among a powder, a wire, an ingot, a shim, a turbine engine component with a brazed joint or a repair area of the turbine engine component made from the nickel based active brazing materials.

10. The nickel based active brazing material according to claim 4, wherein the nickel based active brazing material is selected from among a powder, a wire, an ingot, a shim, a turbine engine component with a brazed joint or a repair area of the turbine engine component made from the nickel based active brazing materials.

11. The nickel based active brazing material according to claim 5, wherein the nickel based active brazing material is selected from among a powder, a wire, an ingot, a shim, a turbine engine component with a brazed joint or a repair area of the turbine engine component made from the nickel based active brazing materials.

12. The nickel based active brazing material according to claim 6, wherein the nickel based active brazing material is selected from among a powder, a wire, an ingot, a shim, a turbine engine component with a brazed joint or a repair area of the turbine engine component made from the nickel based active brazing materials.
